(19) United States
(12) Patent Application Publication
(10) Pub. No.: US 2005/0288955 A1
(43) Pub. Date: Dec. 29, 2005

(54) Real estate transaction automation system and method

(75) Inventor: Kent Lewiss-Hachmeister, Denver, CO (US)

Correspondence Address: GREENLEE WINNER AND SULLIVAN P C, 4875 PEARL EAST CIRCLE, SUITE 200, BOULDER, CO, 80301, US

(73) Assignee: Shark Hunter, L.L.C., Denver, CO (US)

(21) Appl. No.: 11/147,914

(22) Filed: Jun. 8, 2005

Related U.S. Application Data
(60) Provisional application No. 60/583,770, filed on Jun. 29, 2004.

(51) Int. Cl. G06F 17/60

(52) U.S. Cl. 705/1

(57) ABSTRACT

The present invention provides a system and method of automating and streamlining real estate transactions by automatically submitting or transmitting required detailed information to companies providing real estate related services. The information is auto-populated from an electronic real estate form, a computer database, or a software application or internet application used by real estate professionals into an auto-submission screen. Preferably the information contained within an auto-submission screen or screens is electronically transmitted to the service provider through a computer network.

### CROSS-REFERENCE TO OTHER APPLICATIONS

This application claims benefit of U.S. Provisional Application No. 60/583,770, filed Jun. 29, 2004, which is incorporated herein to the extent that there is no inconsistency with the present disclosure.

### BACKGROUND OF THE INVENTION

This invention relates to the field of real estate transactions and automated systems used to complete business tasks or to request services generally performed in the business process of a Realtor®, real estate agent, or other real estate professional, all referred to herein as “real estate professionals”, and the companies real estate professionals do business with.

A real estate professional performs, depending on the type of transaction, several specific business tasks to complete the sale or transaction of real estate. Usually, a real estate professional is utilized to represent the seller of property and/or purchaser of property in a sale and often provides services or recommendations for additional business tasks. The real estate professional provides multiple services such as providing contracts to conduct the sale of the property. Additional business tasks may facilitate, or are required in order to complete the transaction. For example, the real estate professional representing the seller generally contacts a title company to request an Ownership and Encumbrance (O&E) report from a title company; both the seller and buyer of property may have a need for a new mortgage loan; both the seller or the buyer of property may want to be reassured of the quality of the property with a home inspection; both the seller or the buyer of property may want to be protected with a home warranty; a buyer will have need for property insurance; a seller or buyer of property may have a need for home maintenance; and a real estate professional may purchase a gift for either the seller or buyer of property after closing. There are also other steps in the real estate professional's business process not mentioned above.

In the normal course of business, each of these transactions requires individual effort and attention by the real estate professional or individuals employed by the real estate professional. A real estate professional will complete an initial real estate contract for the purpose of listing a property for sale or purchasing a property, as well as for other related purposes. The contract is completed either manually with a pen and paper, or using a computer. If a computer is used, or if the manual entry is later entered into a computer, a large amount of data is available in digital form. Often, the same data is given or re-entered multiple times for different forms and transactions.

When a property is to be sold, the current owner places the property up for sale utilizing a real estate professional, who is considered the Listing Real Estate Agent or Listing Agent. The real estate professional at that time completes a listing agreement to list the property for sale. A multiple listing service (MLS) is a database with comprehensive data on real estate and is often used to list properties for sale and to research properties available for sale. Real estate professionals often utilize such MLS databases, other real estate related databases, as well as other real estate related software, and internet applications to assist in their business process.

Currently, the real estate professional must manually perform the tasks in this process, for example, such as completing an O&E form and faxing this form to a title company. The real estate professional can also go to a title company web site to complete this process. There may be other names for O&E from state to state and company to company, but the content will be substantially identical. The O&E request form requests information from the title company to allow the real estate professional to know the amount owed on the property, and if there are any outstanding liens. Sometimes the title company requires the completed real estate Listing Contract to accompany the O&E, which can require the real estate professional to print the real estate contract and fax many pages to the title company. The time and effort spent in completing this process is independent of the listing agreement process.

When there is a buyer for a property listed for sale, both the seller of the property and the buyer may have a need for a mortgage loan in order for the buyer to complete the purchase and for the seller to purchase a new property. The real estate professional may provide a recommendation to a mortgage banker to obtain a loan and contacts a mortgage banker or mortgage broker. Currently the real estate professional usually makes one or more phone calls to a mortgage banker to request a loan quote for his/her client. The real estate professional may seek loan quotes from several mortgage bankers, and must redundantly provide personal information about the borrower and detailed property information about the transaction each time they speak to a different mortgage banker or broker.

Alternatively, a real estate transaction may involve an exchange of property, such as a 1031 exchange. A 1031 exchange refers to section 1031 of the Internal Revenue Code. A Section 1031 tax-deferred exchange is a real estate “exchange” of two or more properties that allows the taxes due on any capital gains realized on the properties to be deferred until a later date. The property must be in productive use in a business (depreciable property), and can only be exchanged for the same type of property. The rules also require that a qualified intermediary hold the proceeds while the exchange takes place. A real estate transaction involving a 1031 exchange involves a large amount of information that must be transferred between different parties in order to complete the exchange.

A person selling or purchasing a property may also have a need for a property inspection. A property inspection provides a detailed report on the overall condition of the subject property. The real estate professional often orders a property inspection for his/her client from a property inspector or home inspector and may obtain price quotes from several different home inspector companies. The personal information about the client and detailed property information must be provided each time the real estate profession seeks a price quote or orders a property inspection from a different inspector.

Similarly, a prospective buyer or seller may desire a property warranty, which provides comprehensive warranty protection for selected items within a property. Often, the real estate professional completes the application for a home warranty for his/her client. Typically, the lengthy application is complex and is filled out by hand. Alternatively, the real estate professional must go to a web site of a home warranty company and complete the application by entering in the appropriate data.

A prospective buyer or seller may also desire a request for home maintenance service. Often the real estate professional can provide recommendations for home maintenance service. Currently, the real estate professional has to place phone calls to the appropriate service provider giving the required information, and take time to obtain acceptable price quotes and may even meet a contractor at the property.

A buyer of property will also have to acquire property insurance for the property. The real estate professional often provides recommendations for property insurance for his/her client from several different home property insurance companies. The personal information about the client and detailed property information must be provided each time the real estate professional seeks a price or orders insurance from the insurance company.

Additionally a real estate professional may purchase a closing gift for his/her client to express thanks, to congratulate the client on the completion of the transaction, or to foster continuing business relationships. The type of gift varies, however, providing the gift is also currently not automated and requires manual effort.

Other real estate transactions and required accompanying forms depend on the situation, the jurisdiction, local practices, developments in the industry and unusual services (such as need for an engineer's report). Each of these alternatives and the transactions described above require the real estate professional to contact different service providers for each service, and redundantly provide or manually enter similar information regarding the real estate transaction to each service provider for each request. This is inefficient and costly in terms of both time and effort. What is needed is a method of automating this process, eliminating repetitive work effort, and avoiding unneeded re-entry of the same information into multiple forms. Much of the information required by service providers is a subset or similar subsets of a larger set of information, most of which are available to the real estate profession from the initial real estate form or contract stored on an electronic storage device, or from a computer database, software application, or internet application containing comprehensive information relating to the real estate transaction.

### SUMMARY OF THE INVENTION

The present invention provides a system and method of automating and streamlining real estate transactions or third party real estate related service requests by automatically submitting or transmitting required detailed information to companies providing real estate related services. Specific information or data that is to be transmitted to a company providing a real estate related service, herein referred to as a “service provider”, is auto-populated into an auto-submission screen, combined with any additional information which is manually entered by the real estate professional, and transmitted to the appropriate service provider. In one embodiment of the present invention, data is auto-populated from a source such as: A) a real estate form or contract stored on an electronic storage device, B) a software or internet application containing comprehensive information relating to the real estate transaction, or C) a computer database. Multiple sources containing the data that is to be transmitted to the service provider may be available, but it should be understood that these sources are independent from each other and the data may be auto-populated from any one of the individual sources. As used herein, the term “auto-populate” or “auto-population” refers to a process where information from a data source is selected and imported into a different data file without the need for additional intervention or instructions from a user. As used herein, “auto-submission screens” are electronic files or forms generated by a computer program able to hold and display the imported or auto-populated data for the specific selected service provider, allowing the user to view and modify the information contained in the auto-submission screen.

Exemplary sources, from which data and information are auto-populated, are further described as follows:

A) A “real estate form” is any real estate contract or form used by real estate professionals stored in an electronic format and having information relating to a real estate transaction. For example, when a real estate professional represents a person selling a property he or she is considered to be the Listing Agent and typically completes a Listing Contract, and when the real estate professional represents a person buying a property he or she is considered to be the Buyer Agent and typically completes a Buy/Sell Contract. There may be other names for Listing Contract and Buy/Sell Contract from state to state and jurisdiction to jurisdiction, but the content of the contracts will be substantially the same. Real estate professionals typically use software programs, such as a word processing program, ZipForm® (from ZipForm/RE FormsNet, 18025 15 Mile Rd., Clinton Twp., Mich. 48035), or RealFast® (Realfast, Inc., 721-B Granite Street, Frisco, Colo. 80443), to create electronic real estate contracts or forms. Alternatively, real estate forms originally completed using pen and paper can be subsequently entered into a computer.

The electronic real estate form may also be part of a program that generates the auto-submission screens. One embodiment of the present invention comprises a computer program able to auto-populate data into an auto-submission screen and electronically transmit the auto-submission screen to a service provider. In a further embodiment, the program generates an electronic front-end real estate form where a user can enter and store information relating to a real estate transaction. The program auto-populates the data from the front-end real estate form into the auto-submission screens. Since the information has been stored in the front-end real estate form, the user can auto-populate multiple auto-submission screens without having to re-enter the information.

B) Real estate professionals often purchase software and internet applications containing comprehensive real estate related data, including, but not limited to: applications used for real estate research, sales and marketing, and client management. Examples of such software or internet applications having comprehensive real estate data include eNeighborhoods™ (eNeighborhoods Inc., One Park Place, Suite 450, Boca Raton, Fla. 33487), Top Producer® (TOP PRODUCER Systems, Unit #103-Campus Park, 34310 9th Ave South, Federal Way, Wash. 98003), and MetroScan (by Transamerica Information Managements Services, 1860 Howe Avenue #455, Sacremento, Calif. 95825).

C) Comprehensive information relating to a real estate transaction is also retrieved from electronic databases. The database can be stored on an electronic storage device, such as a computer processor, the hard drive of a computer, a disk, CD, DVD, or any electronic storage means known in the art, and is optionally part of a software or internet application. Preferably the database is stored on a server allowing access to the database from multiple computers. One example of a database containing information relating to real estate transactions is a MLS. A MLS is a database used by real estate professionals to list properties for sale and contains comprehensive real estate information, such as but not limited to: the seller's name, legal description of the property, location of the property and the asking price for the property. Local county assessor's offices and county clerk's offices also often provide electronic databases, available through the internet, containing information on the property owner, property deeds, mortgages, tax liens, parcel location, legal description, and tax information.

Specific information or data that is to be sent to a service provider, is auto-populated from the electronic real estate form, database, software application or internet application into an auto-submission screen, combined with any additional information manually entered by the real estate professional, and transmitted to the appropriate service provider. Preferably a request for a service containing the information contained within the auto-submission screen is electronically transmitted through a computer network to the service provider. As used herein, a “network” is a system of computers interconnected by telephone wires, cables, or other connection means known in the art, including wireless communication, allowing an electronic signal coding for information to be sent from one computer connected to the network to another computer connected to the network. Alternatively, the auto-submission screen is transmitted to a service provider through non-computer means, such as by facsimile. Once received by the service provider, the information from the auto-submission screen can be read, such as in the case of, but not limited to, an email or instant text message, or the information can be auto-populated into a computer database, software application, or internet application used by the service provider to process requests for that particular service. For instance, an information processing center for a title company providing O&E information may utilize an electronic database. The database is auto-populated with the information from the auto-submission screen which has been transmitted in the request and generates an O&E report based on that information and the information already compiled in the database. In another example, data contained in the request is auto-populated into a software application, such as Calyx Point® (Calyx Software, 6475 Camden Avenue, Suite 207, San Jose, Calif. 95120-2848), used by a mortgage broker to complete forms related to the mortgage industry.

Examples of the type of data which may be auto-populated into the auto-submission screen include, but are not limited to: name, address, and phone number of the buyer and/or seller; name, address, and phone number of the real estate professional; the address and legal description of the property or properties in question; purchase amount, down payment amount and closing date; and name of person requesting a property inspection, warranty, or maintenance service. Methods of identifying data to enable searching, retrieving, and analyzing information through automated means are well known in computing and information processing and can be used with the present invention. For example, data tagging is a process of assigning a unique label to specific data elements. In one embodiment, data relating to a real estate transaction, such as the name of the buyer, is tagged when it is contained in the real estate form, database, software or internet application. The present invention auto-populates the data associated with the tag into the appropriate field in the auto-submission screen.

The present invention automatically submits requests for one or more services including, but not limited to, title information, mortgage loans, property inspections, property insurance, property warranties, property maintenance, 1031 exchanges, contractor referrals, commission advances, quotes for the above services, and combinations thereof. Additionally, concierge services and closing gifts can be automatically purchased from participating vendors using the present invention. The present invention can also encompass services not listed above which require information relating to a real estate transaction, wherein that information can be auto-populated from a data source. Depending on the service to be requested, the specific data that needs to be transmitted will vary. For example, information on the purchase amount of the property may be required for a home mortgage loan quote, which is readily available in a Buy/Sell Contract, while the name of the owners selling the property may be required for a request for title information, which is available in a Listing Contract. The present invention identifies and copies the data within the real estate form, database, software application or internet application that is necessary in order to request the specific service.

In one embodiment of the present invention, a computer program identifies the data in the real estate form, database, software application or internet application related to a real estate transaction. From this data set, the appropriate data subset necessary for requesting the selected service from a service provider is auto-populated into an auto-submission screen. Thus, when a specific service is determined or selected, the program automatically copies the relevant information from the real estate form, database, or application into the auto-submission screen.

The auto-submission screens are preferably electronically transmitted to the service provider. As used herein, the term “electronically transmitted” or “electronically transmitting” refers to the sending of electronic signals carrying data, as ordinarily understood in the art, from one computer processor to a second computer processor. Means for sending and receiving electronic signals carrying data are widely known in the art, such as through wired computer networks or wireless communication, including satellite transmission. Electronically transmitting a signal carrying data may also include the use of transfer protocols as known in the art, including but not limited to file transfer protocol (FTP), Transmission Control Protocol/Internet Protocol (TCP/IP), User Datagram Protocol (UDP), and packet relay; programming and markup languages known in the art, including but not limited to HTML, XML, and Javascript; and file sharing models known in the art, including but not limited to peer-to-peer file sharing. In one embodiment, the data contained in the electronically transmitted auto-submission screens is sent to the service provider in the form of an email request, or instant text message request. Alternatively, the data is transmitted and auto-populated into a database, software application, or internet application operated or accessible to the service provider.

The computer program is stored on an electronic storage device, such as a disk, CD, DVD, the hard drive of a computer, a computer processor, or any other electronic storage devices known in the art. Preferably, the program is an internet application stored on the hard drive of a server and made accessible on the internet.

One embodiment of the present invention is a method of automating a real estate transaction comprising the steps: identifying a data set relating to the transaction in an electronic real estate form, database, software application, or internet application; auto-populating a subset of said data set into at least one auto-submission screen; and electronically transmitting said at least one auto-submission screen containing said data subset to at least one service provider, wherein said data subset contains information necessary to request a service from the service provider. Additional information is optionally entered and combined with the data subset prior to transmitting the data contained in the auto-submission screen. Optionally, the additional information is entered by selecting one or more features in the auto-submission screen, or typed into the auto-submission screen through a keyboard. In a further embodiment, more than one auto-submission screen can be auto-populated and transmitted for the same real estate transaction. These multiple auto-submission screens can be for the same service, such as requests for a loan quote sent to different mortgage companies, or for different services, such as a request for a loan quote sent to a mortgage company and a request for title information sent to a title company.

Another embodiment of the present invention is a method of automating a real estate transaction comprising generating an auto-submission screen on a computer screen. Each auto-submission screen corresponds to one or more auto-submission processes representing the real estate related services. In a further embodiment, more than one auto-submission screens are generated transmitted to different service providers. The method further comprises linking the auto-submission screen with an electronic real estate form, database, software application, or internet application containing information relating to the transaction stored on an electronic storage device; identifying a data set relating to the transaction in the electronic real estate form, database, software application, or internet application; extracting a subset of the data set from the electronic real estate form, database, software application, or internet application; auto-populating the data subset into the auto-submission screen; and electronically transmitting a request for a service to a service provider, wherein the request comprises the data subset contained in the auto-submission screen. By linking the auto-submission screens with an electronic real estate form, database, software application, or internet application, it is meant the auto-submission screens are able to access the electronic real estate form, database, software application, or internet application and auto-populate the necessary data. The necessary data will vary depending on the information required by the different real estate related service providers. The computer program generating the auto-submission screens and the real estate form, database, software application, or internet application may be on the same computer processor or on different processors connected to each other through a network.

Another embodiment of the present invention is a computer system comprising (a) a server connected to a plurality of computers through a network; (b) an automation program stored on the server, wherein the program is able to identify a data set relating to a real estate transaction in an electronic real estate form, database, software application or internet application stored on an electronic storage device, auto-populate a subset of the data set into at least one auto-submission screen, and electronically transmit at least one auto-submission screen containing the data subset to at least one service provider; and (c) a back-end database stored on said server, where the back-end database comprises account information on the transmitted auto-submission screens. Preferably, the real estate form, database, software application or internet application is stored on a computer processor connected through a network to the server, allowing the program to access the real estate form, database, software application or internet application. It is also preferred that the computer processors accessible or operated by the service providers are also connected to the server through the computer network.

The account information contains information including, but not limited to, electronic records on the number of auto-submission screens transmitted, the entities receiving the auto-submission screens, the entities who submitted the auto-submission screens, and the amount charged for each transmitted auto-submission screen. In a further embodiment, the entity operating the server and/or automation program charges a fee for generating or transmitting the auto-submission screens. The fee may be assessed to either the service providers, the real estate professional requesting the service, or both. To have access to the server and/or the automation program, the service provider or real estate profession must sign up for an account. With an account on the database, users are able to store, retrieve and re-submit auto-submission screens on the server. The back-end database optionally provides tracking for auto-submission screens, adds up total charges, and provides automatic billing invoices.

### BRIEF DESCRIPTION OF THE DRAWINGS

FIG. 1 is a diagram illustrating the basic process steps of one embodiment of the invention.

FIG. 2 is a schematic block diagram of a computer used by a real estate professional connected through a network to a database computer and multiple service provider computers.

FIG. 3 shows a computer screen having a menu display of the present invention having multiple auto-submission selection buttons.

FIG. 4a shows a title information auto-submission screen containing auto-populated information. FIG. 4b shows a title information supplementary screen that allows a user to enter or select additional information.

FIGS. 5a and 5b show mortgage loan quote auto-submission screens of one embodiment of the invention containing auto-populated information and additional information entered or selected by a user.

FIGS. 6a and 6c show property inspection auto-submission screens of one embodiment containing auto-populated information and additional information entered or selected by a user. FIGS. 6b and 6d show property inspection supplementary screens that allow a user to enter or select additional information specific for the inspection company and service to be provided.

FIG. 7a shows a 1031 exchange supplementary screen containing contact information which can be selected or entered by a user. FIG. 7b shows a 1031 exchange auto-submission screen containing auto-populated information and additional information entered or selected by a user.

FIG. 8a shows a property insurance supplementary screen containing agent and contact information which can be selected or entered by a user. FIG. 8b shows a property insurance auto-submission screen containing auto-populated information and additional information entered or selected by a user.

FIGS. 9a and 9b show property warranty supplementary screens that allow a user to select or enter additional information necessary to request a home property warranty request. FIG. 9c shows a property warranty auto-submission screen containing auto-populated information and additional information entered or selected by a user.

FIG. 10a shows a property maintenance supplementary screen containing services and contractor information, which can be selected or entered by a user. FIG. 10b shows a property maintenance auto-submission screen containing auto-populated information.

FIGS. 11a and 11c show commission advance supplementary screens, while FIG. 11b shows a commission advance auto-submission screen containing auto-populated information and additional information entered or selected by a user.

FIG. 12 shows a purchasing closing gift auto-submission screen.

### DETAILED DESCRIPTION OF THE INVENTION

The following embodiments and examples are provided in order to illustrate the invention and are not meant to limit the scope of the invention. It is understood that the invention may encompass alternative embodiments that one of ordinary skill in the art would be able to understand and use without undue experimentation. Unless otherwise defined, all technical terms used herein are given the same meaning as would be commonly understood by one skilled in the art to which the term pertains.

In an embodiment of the present invention, a real estate professional utilizes a computer program to collect and submit information in order to request a real estate related service from a service provider. The specific information necessary for the request is taken from a completed real estate form (for example, a real estate contract such as a completed Buy/Sell Contract or a completed Listing Contract) that is in electronic form and auto-populated into an auto-submission screen. Alternatively, real estate related data is auto-populated into the auto-submission screen from separate databases, and real estate software applications or internet applications currently used by real estate professionals.

In one embodiment, an access button or icon is available on the user's computer screen enabling the user to access the program. The access button and accompanying program generating the auto-submission screens can be installed on the user's computer, made available through a software application on a disk, DVD or CD, or made available through the internet. In one embodiment, the access button or icon is available on the user's computer screen while a separate application of either an electronic real estate form, database, software or internet application is in use. When the access button is selected, a menu display window having one or more auto-submission selection buttons appears on the computer screen. Each auto-submission selection button corresponds to a real estate related service. For example, the program provides auto-submission selection buttons for services such as title information, property inspections (particularly home inspections), mortgage loan quotes, property warranties (particularly home warranties), property maintenance, property insurance (particularly home insurance), 1031 exchanges, commission advances, and purchasing closing gifts.

The present invention can be utilized by placing the access button on a separate and independent electronic real estate form application, database, or software or internet application. The present invention identifies the information in the real estate form, database, or software or internet application that is relevant for the request for that service provider and auto-populates that information into the auto-submission screen. Optionally, the auto-submission screen contains a supplementary menu allowing the user to select additional information to be included in the auto-submission screen. Additional information can also be manually entered into the auto-submission screen. Once the entered and selected information has been added to the auto-submission screen, the user can view the screen to verify that all necessary information for the request is present.

In a further embodiment of the invention, the computer program allows the user to determine the service provider that the request is being transmitted to. This is accomplished through selecting a service provider from the supplementary menu, or entering identifying information, such as an email address, into the screen. The information in the auto-submission screen is then electronically transmitted to a service provider as part of a request for a service.

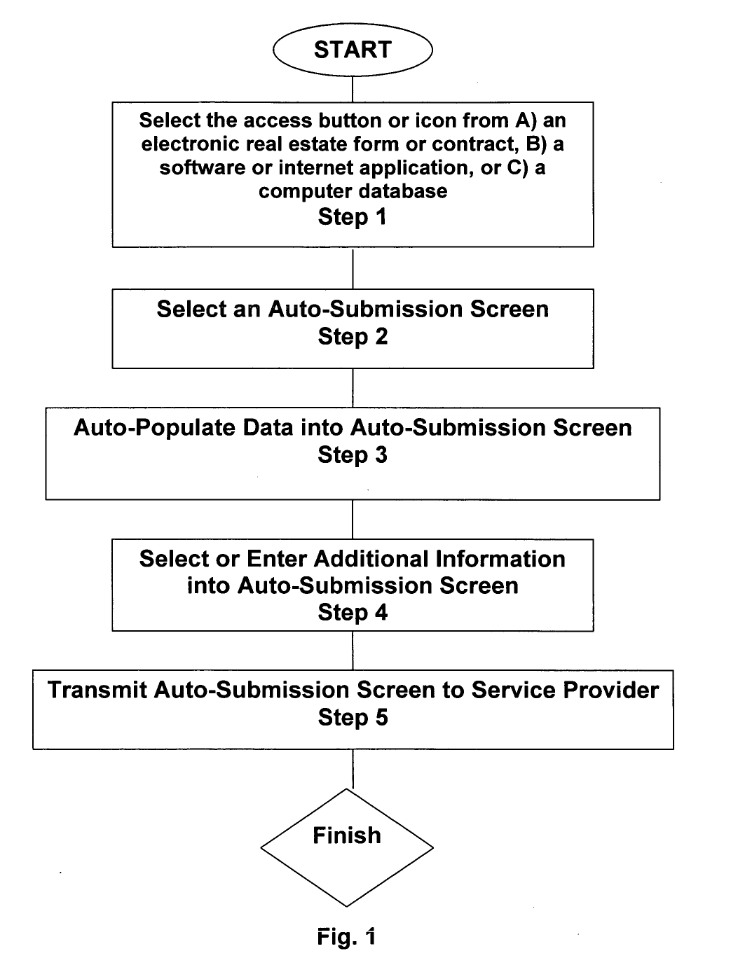

FIG. 1 further illustrates the basic process steps of one embodiment of the present invention. In this embodiment, an access button or icon is available on the user's computer screen while an electronic real estate form, database, software or internet application is in use. The user selects the access button or icon causing one or more auto-submission selection buttons to be displayed. The user then selects an auto-submission screen corresponding to the service to be requested by selecting the corresponding auto-submission button. When the access button or icon is selected while a real estate form, database, software or internet application is in use, the open real estate form, database, software or internet application is automatically selected as the source of the data to be auto-populated into the auto-submission screen. Additional information is entered or selected and the auto-submission screen containing the combined auto-populated information and additional information is transmitted to the service provider. Although not illustrated in FIG. 1, the additional information is optional and can be entered or selected before or after the data is auto-populated into the auto-submission screens.

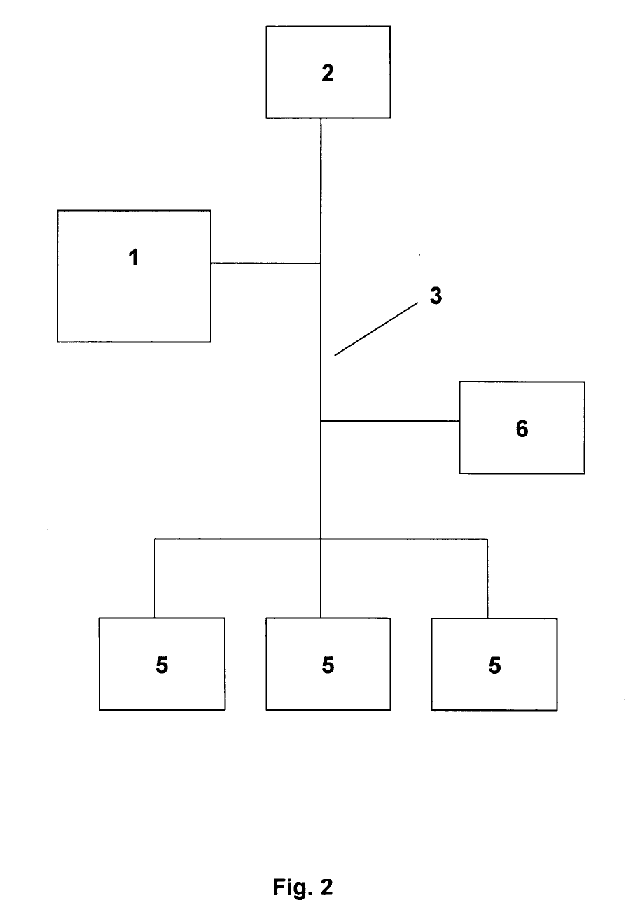

FIG. 2 shows a real estate computer 1 used to request a real estate related service through a network 3. In one embodiment, a computer program able to auto-populate auto-submission screens or screens from an electronic real estate form, database, software or internet application is stored on real estate computer 1. An electronic database is stored on database computer 2, which is connected to real estate computer 1 through network 3. The electronic database is thus accessible to the program stored on real estate computer 1, allowing the real estate information contained in the database to be copied and auto-populated into the auto-submission screens or screens generated by the program. Real estate computer 1 is also connected through network 3 to a plurality of service provider computers 5. Real estate computer 1, database computer 2, and each of the service provider computers 5 may be at different geographic locations. After the real estate information from the database is auto-populated, the auto-submission screens or screens are electronically transmitted through network 3 to one or more of the service provider computers 5.

In another embodiment, the computer program is stored on remote computer 6, which is connected to real estate computer 1, database computer 2, and service computers 5 through the network 3. Real estate computer 1 is thus able to access the computer program on remote computer 6 through the network 3, and direct the computer program to auto-populate the information stored on database computer 2 into an auto-submission screen or screen, and transmit the auto-submission screen or screen to one of the service provider computers 5.

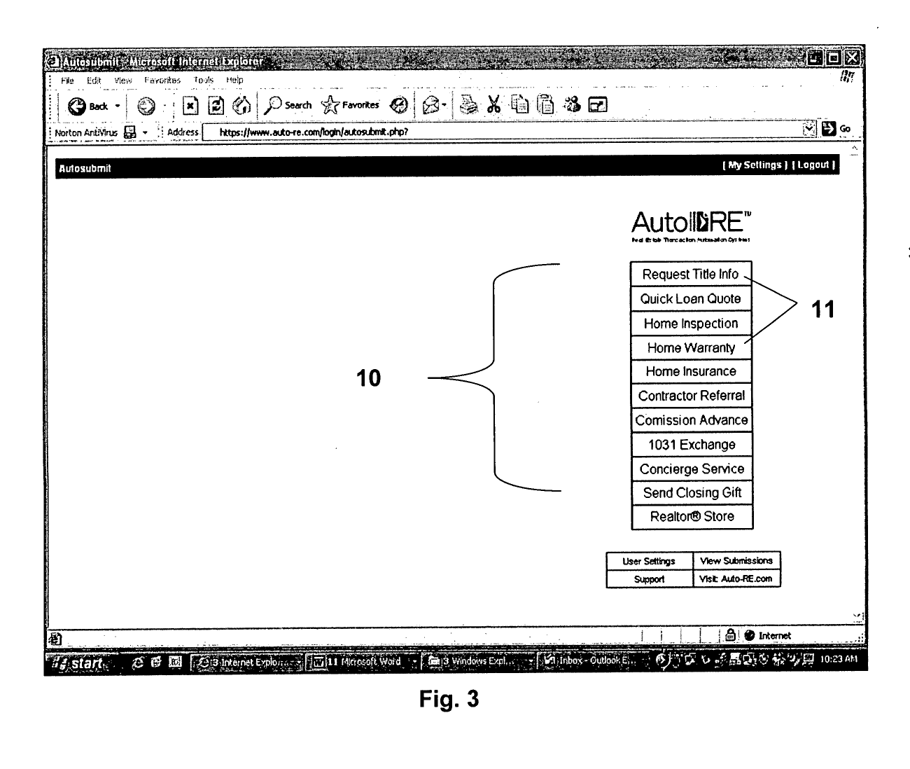

FIG. 3 shows a computer screen displaying a menu display 10 of one embodiment of the present invention. Menu display 10 has multiple auto-submission selection buttons 11 labeled as Request Title Info, Quick Loan Quote, Home Inspection, Home Warranty, Home insurance, Contractor Referral, Commission Advance, 1031 Exchange, Concierge Service, and Send Closing Gift. In different embodiments, the menu display 10 may have the same or different selection buttons 11, or use different labels for the selection buttons 11 as depicted in FIG. 3. Selecting any of the auto-submission selection buttons 11 will generate the corresponding auto-submission screen or screens. Menu display 10 can be displayed as part of an auto-submission screen or supplementary screen, allowing a user working on the auto-submission screen or supplementary screen to generate new auto-submission screens.

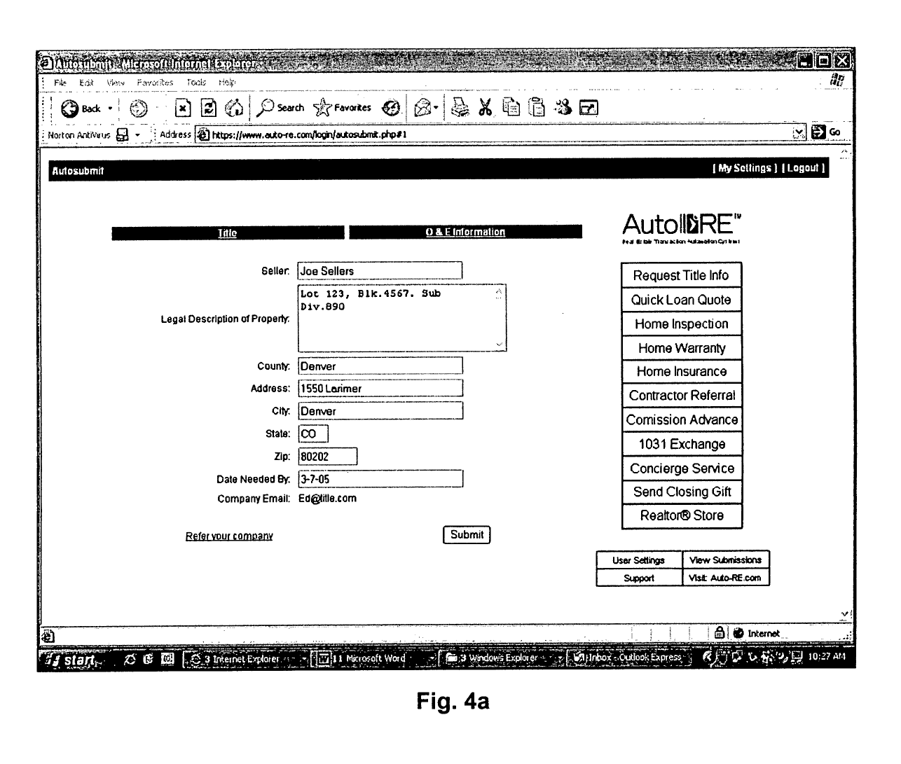

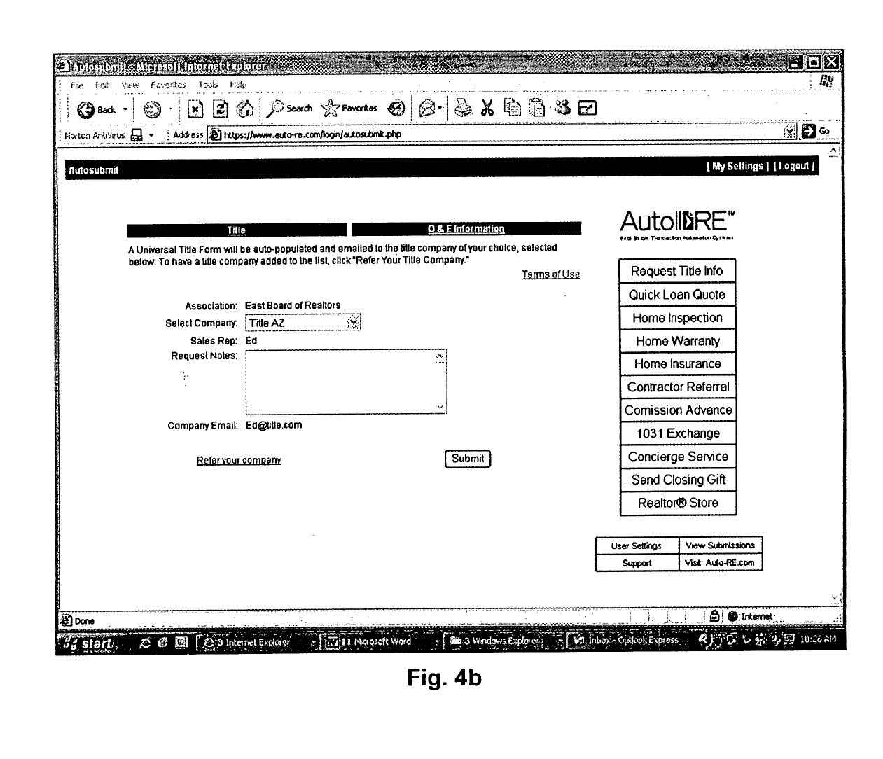

FIGS. 4 through 11 illustrate auto-submission screens and supplementary screens for different real estate related services generated in one embodiment of the present invention. The accompanying descriptions recite the type of information that is auto-populated, selected or entered into the screens. These descriptions are not meant to be limiting. It is within the scope of this invention that the auto-submission and supplementary screens, or variations of the auto-submission and supplementary screens, contain additional auto-populated, selected or entered information or different information than what is provided in the examples. As depicted in FIGS. 4 through 11, the auto-submission and supplementary screens are displayed utilizing Microsoft Internet Explorer and a Windows operating system, however, it is to be understood that this invention can be displayed using other operating systems and programs, and does not necessarily require an internet browser.

FIG. 4a is a screen shot of a title information auto-submission screen that has been auto-populated with information from a real estate form, database, software application or internet application. The title information auto-submission screen contains data including seller's name, legal description of the property, and property address, which may include the county, city, state, and zip code where the property is located. The auto-populated information can be edited, and additional information, such as the date the title information is needed by, can be added in this screen. This eliminates the need to manually fill out the O&E, or other title request form, with a writing utensil and fax the paperwork to the title company. FIG. 4b is a screen shot of a title information supplementary screen that allows a user to enter comments and select to which title company the title request is to be sent. The information in the title information supplementary screen is combined with the information in the title information auto-submission screen and transmitted to the title company.

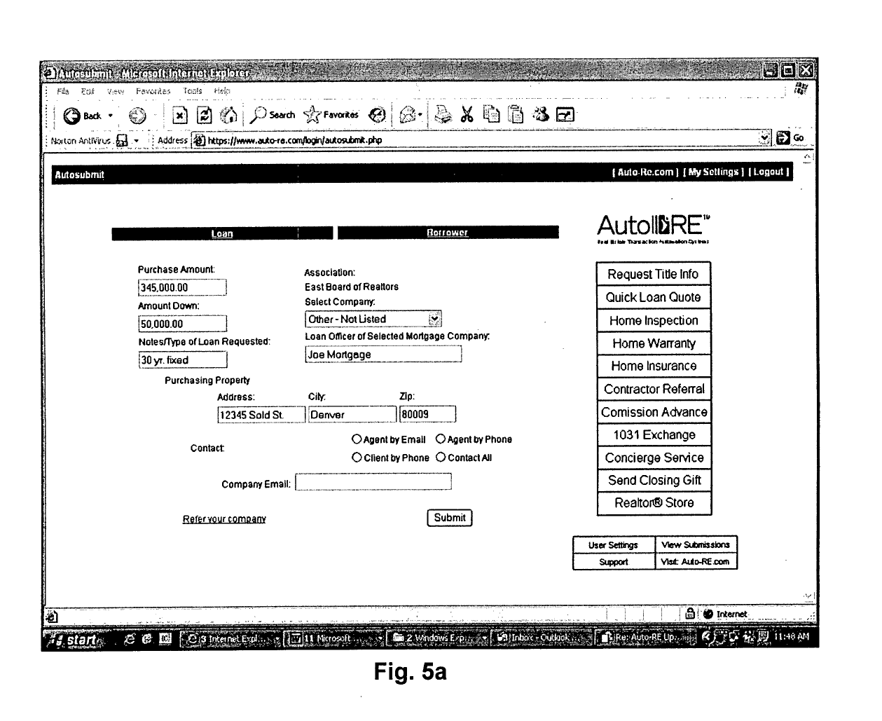

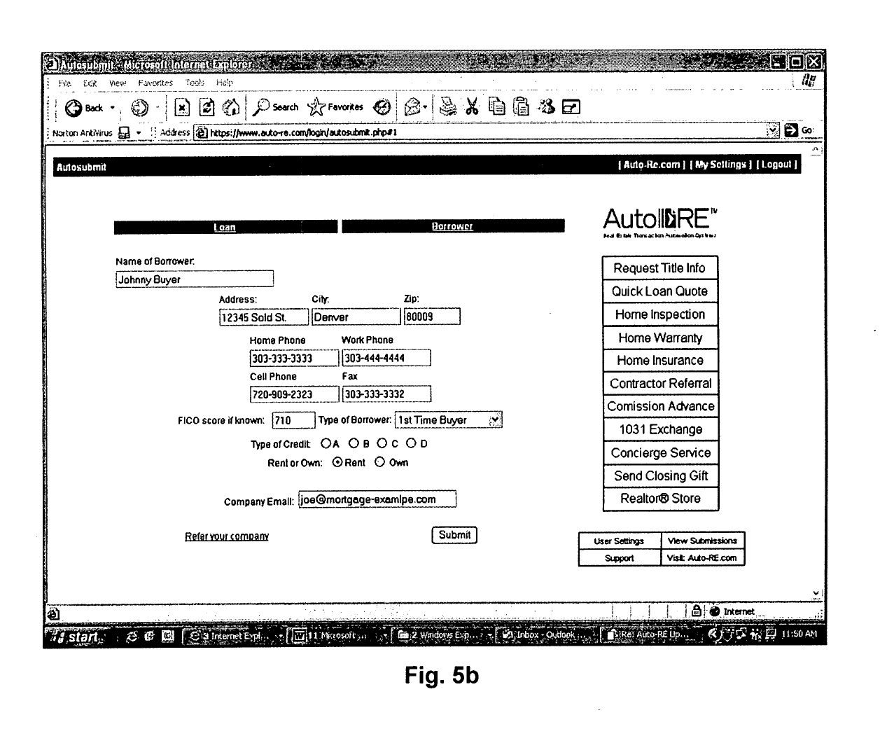

Currently, in order to request a loan quote, detailed information on the real estate professional, detailed borrower information, and detailed property information are relayed to the mortgage banker or mortgage broker over the phone or via facsimile. With the present invention, several loan quotes can be obtained without relaying the information several times. If the mortgage loan request is made on behalf of the buyer, the auto-submission screen will contain data including the buyer's name, the property address, which may include the city, state, and zip code, purchase amount, down payment amount, and the contact information (such as home phone number, work number, mobile phone number, address, facsimile number, or email address) for the buyer. If the mortgage loan request is made on behalf of the seller, the auto-submission screen will generally include the seller's name, current property address, and the contact information for the seller. FIGS. 5a and 5b are screen shots of mortgage loan auto-submission screens, which are generated when the mortgage loan quote selection button is selected. The mortgage loan auto-submission screen shown in FIG. 5a contains data regarding the loan, including auto-populated information, such as the address of the purchased property, and selected or entered information, such as the type of loan requested. The mortgage company and loan officer are also selected in this screen. The auto-submission screen shown in FIG. 5b contains data regarding the borrower, including auto-populated information, such as the name and contact information of the buyer or seller (depending on who is requesting the loan), and selected or entered information, such as the type of borrower and the type of credit the borrower has. The auto-submission screens allow a user to add or edit the information in order to, for example, correct a mistake or to update the borrower's contact information. The information from both mortgage loan auto-submission screens are combined and transmitted to the selected mortgage company or companies.

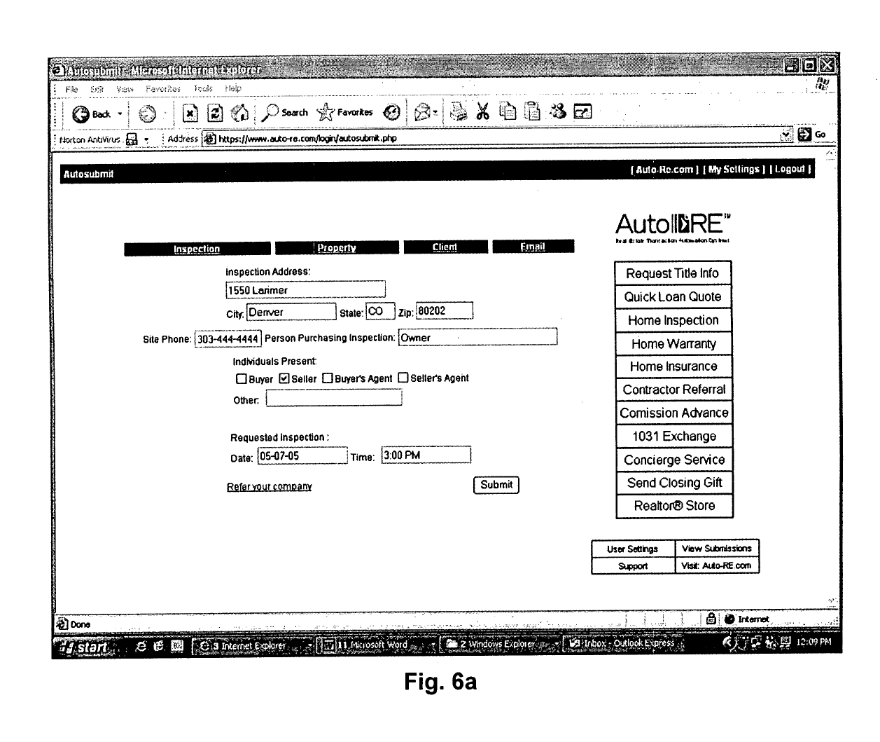

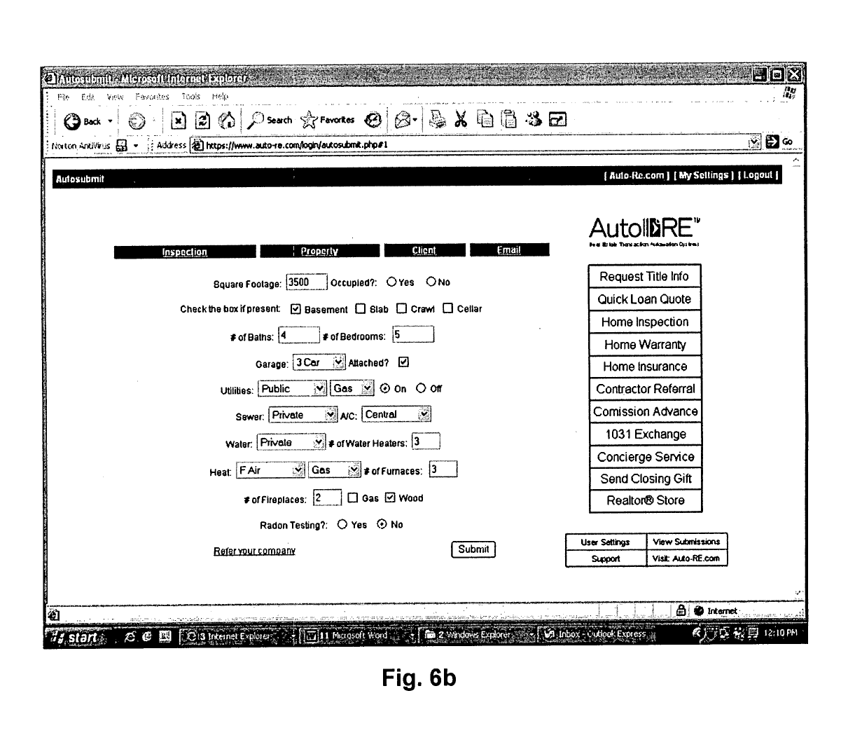

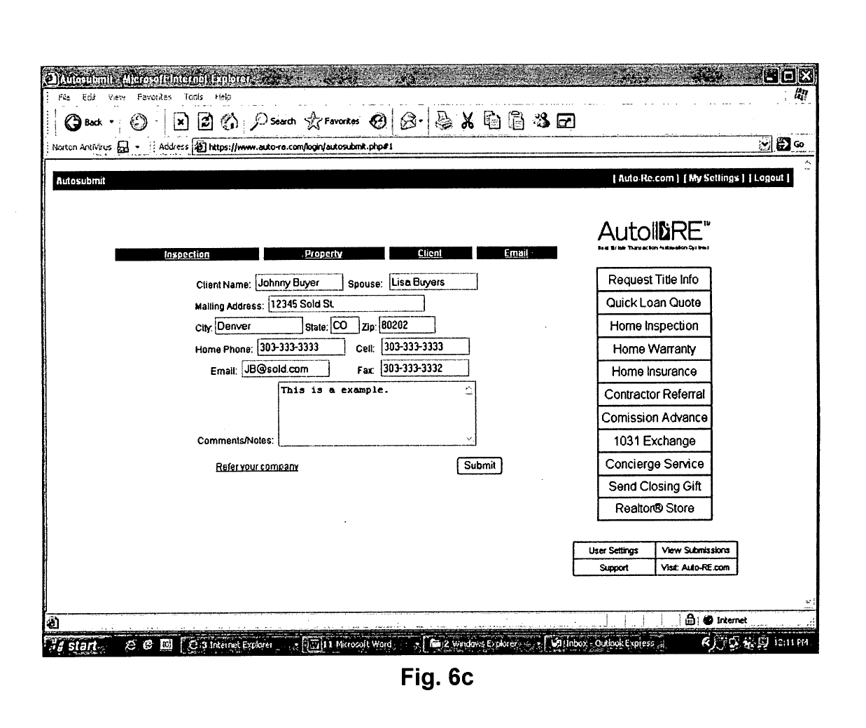

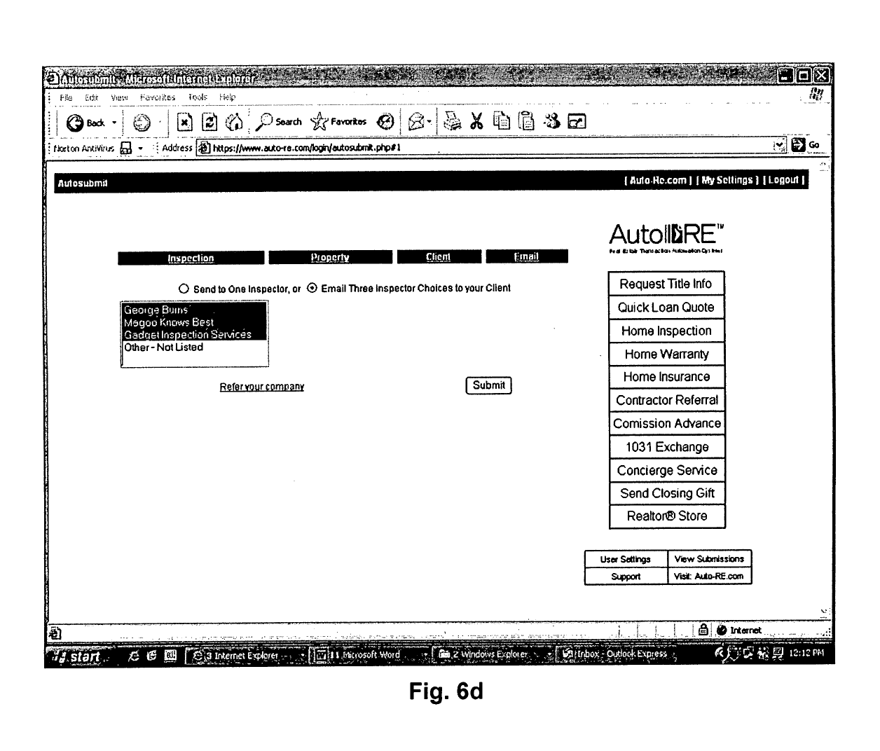

FIGS. 6a through 6d show property inspection auto-submission screens and property inspection supplementary screens. Typically, the property inspection request is for a home inspection. The property inspection auto-submission screens electronically provide information that is provided to the home inspection company over the phone, and generally contain the buyer's name or seller's name, property address, city, state, zip code, legal description, and contact information for the buyer or seller. By electronically transmitting the inspection request, the need to relay this information several times to different home inspection companies is eliminated. The property inspection auto-submission screen depicted in FIG. 6a contains auto-populated information, such as the property address, and selected or entered information, such as the date and time the inspection is requested to take place. The property inspection auto-submission screen depicted in FIG. 6c similarly contains auto-populated information, such as the name and contact information of the buyer or seller (depending on who is requesting the inspection). The property inspection supplementary screen depicted in FIG. 6b allows the user to select or enter the physical description of the property, including the square footage, number of bedrooms and bathrooms, and the type of utilities. The property inspection supplementary screen depicted in FIG. 6d allows the user to select the inspector, or inspectors, that the inspection request is sent to.

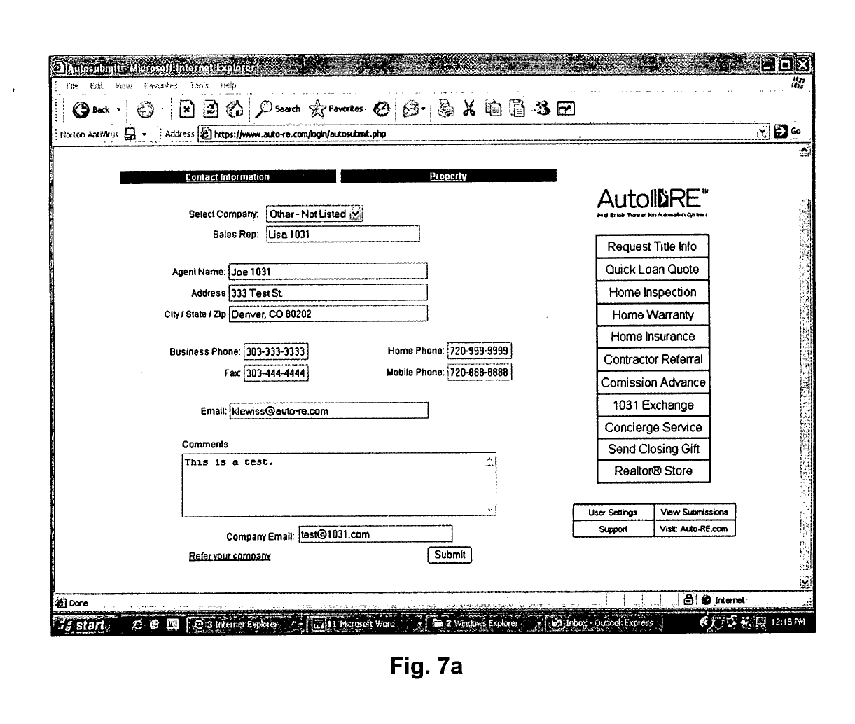

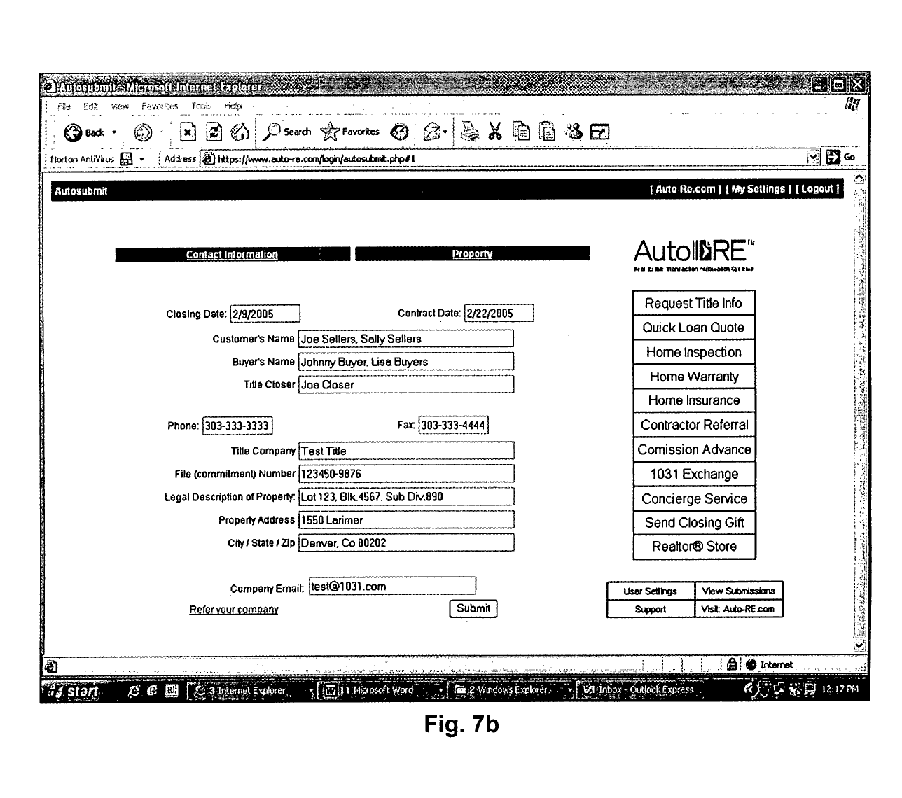

FIG. 7a shows a 1031 exchange supplementary screen which allows the user to enter or select information such as the name and contact information of the agent handling the exchange. FIG. 7b shows a 1031 exchange auto-submission screen. The 1031 exchange auto-submission screen contains auto-populated information such as the buyer's name or seller's name, property address, legal description, and contract date. Additionally, the screen can also have the closing date. The 1031 exchange auto-submission screen also allows the user to enter or select additional information such as the name of the title company and title closer.

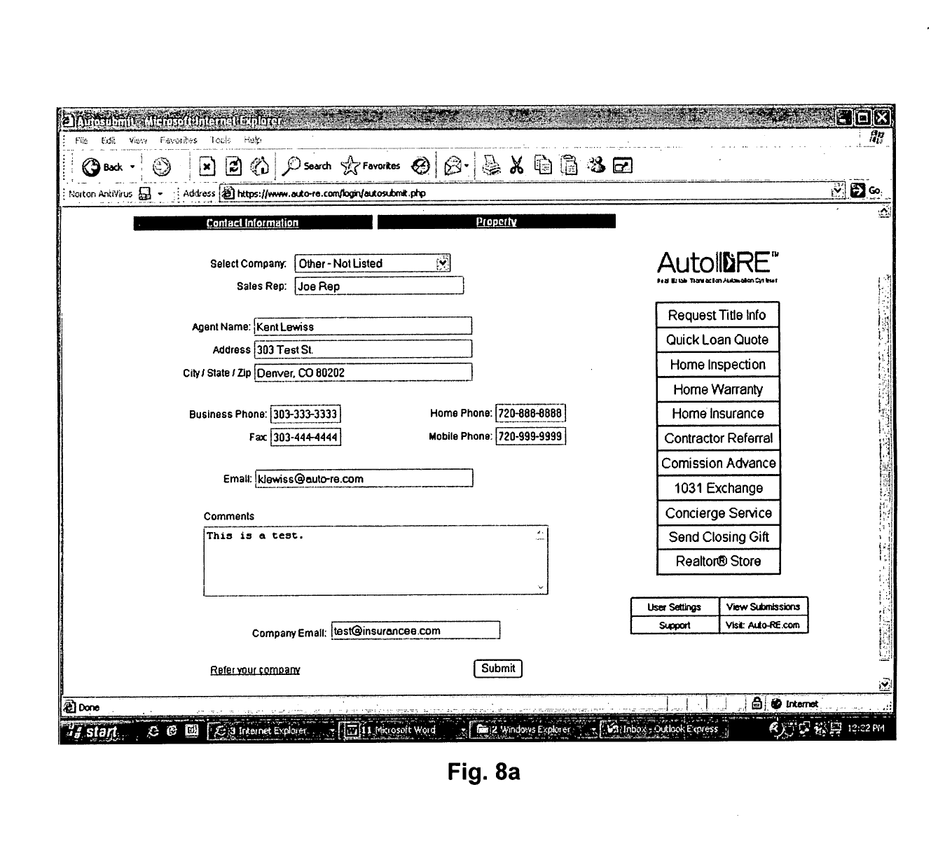

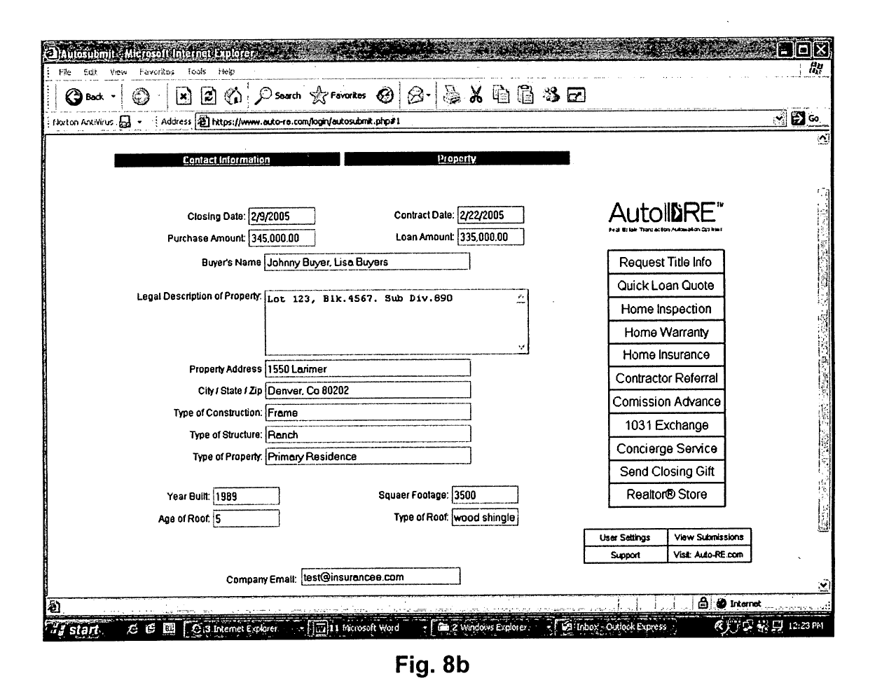

FIG. 8a shows a property insurance supplementary screen which allows the user to enter or select the insurance company and sales representative to whom the property insurance request is being sent, and the name and contact information of the real estate agent sending the request. Often the request for property insurance is for a request for home insurance. FIG. 8b shows a property insurance auto-submission screen. The property insurance auto-submission screen generally contains the buyer's name, legal description of the property, and property address, which may include the city, state, and zip code. The property insurance auto-submission screen may also comprise the purchase amount, closing date, contract date and loan amount. The property insurance auto-submission screen also allows the user to enter or select additional information useful or necessary in obtaining insurance, such as the year the building was built, type of structure, and square footage.

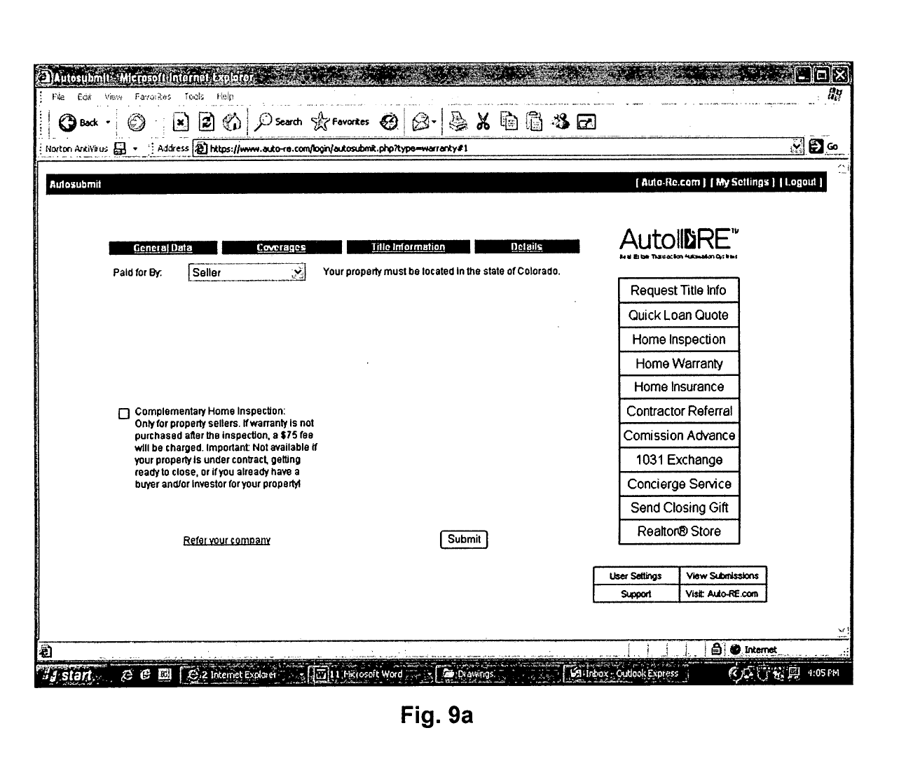

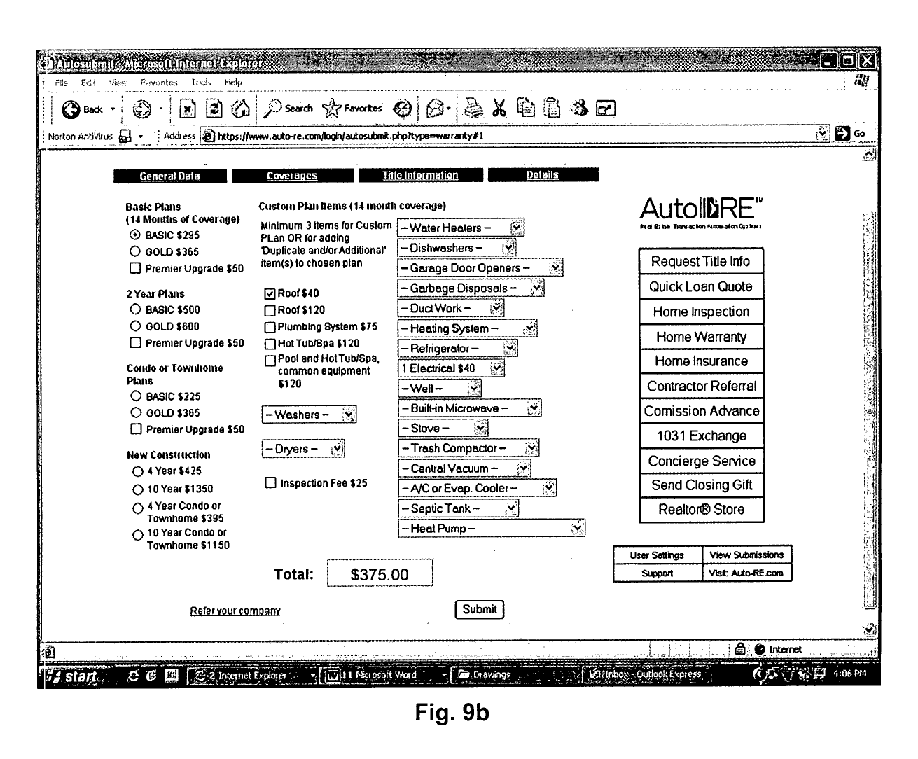

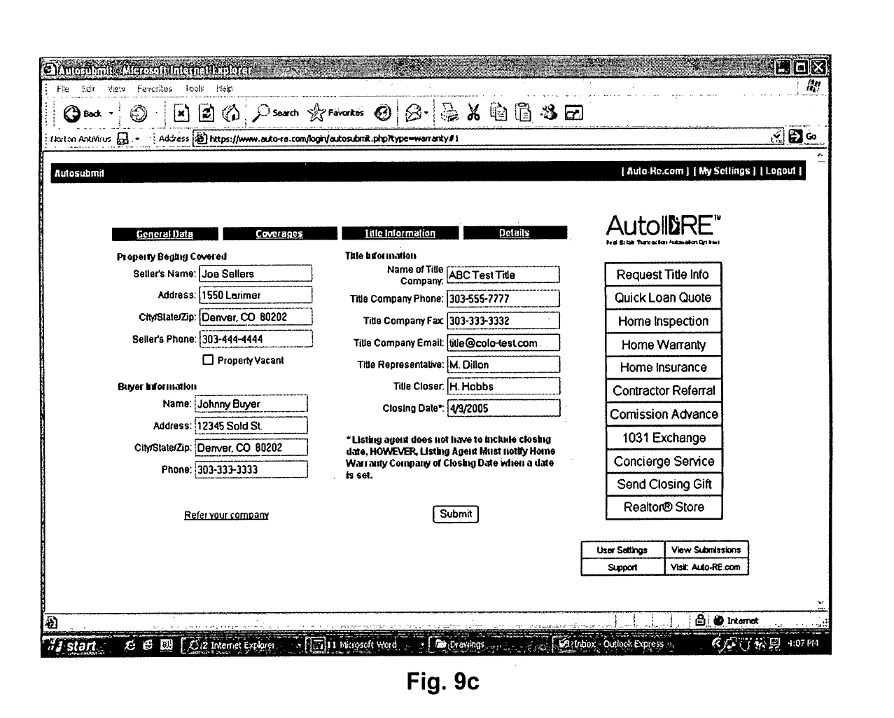

Presently, a request for a property warranty, particularly a home warranty, is generally provided to the home warranty company by completing a complicated application with a writing utensil and calculator or on a web site. Utilizing the present invention to electronically transmit the necessary information eliminates the need to complete home warranty applications manually. FIGS. 9a and 9b show property warranty supplementary screens which allow the user to enter or select whether the buyer or seller is paying for the warranty, the type or warranty plan requested, and the items covered by the warranty. The property warranty auto-submission screen shown in FIG. 9c contains auto-populated information such as the buyer's name and seller's name, the address of the property being covered, and contact information for the buyer and seller. The property warranty auto-submission screen also allows the user to enter or select the name and contact information of the title company, name of the title closer, and the closing date.

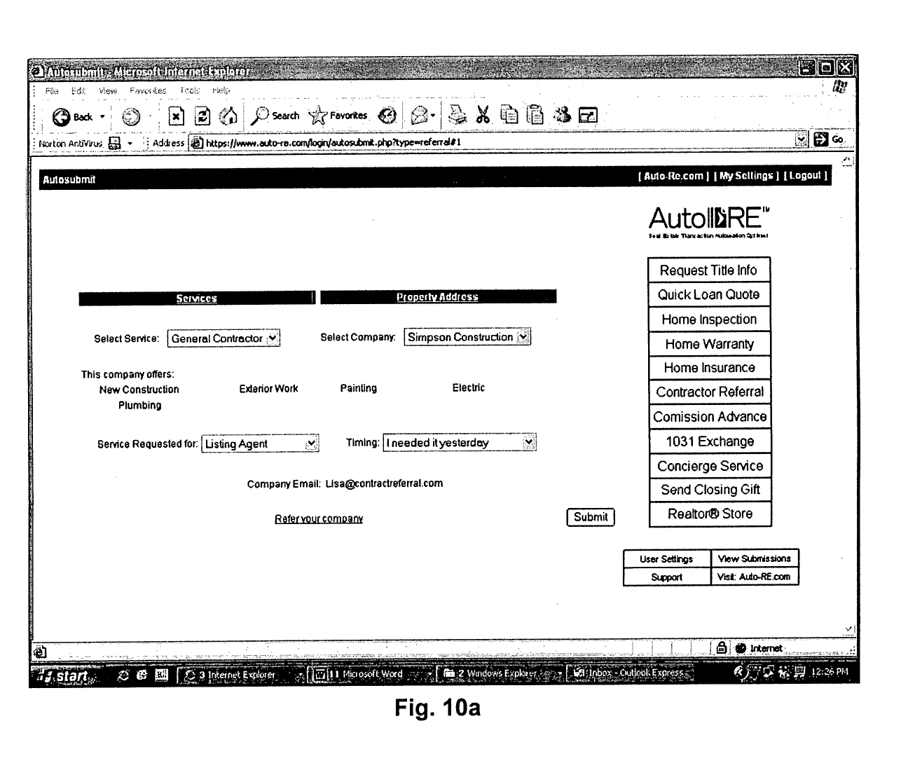

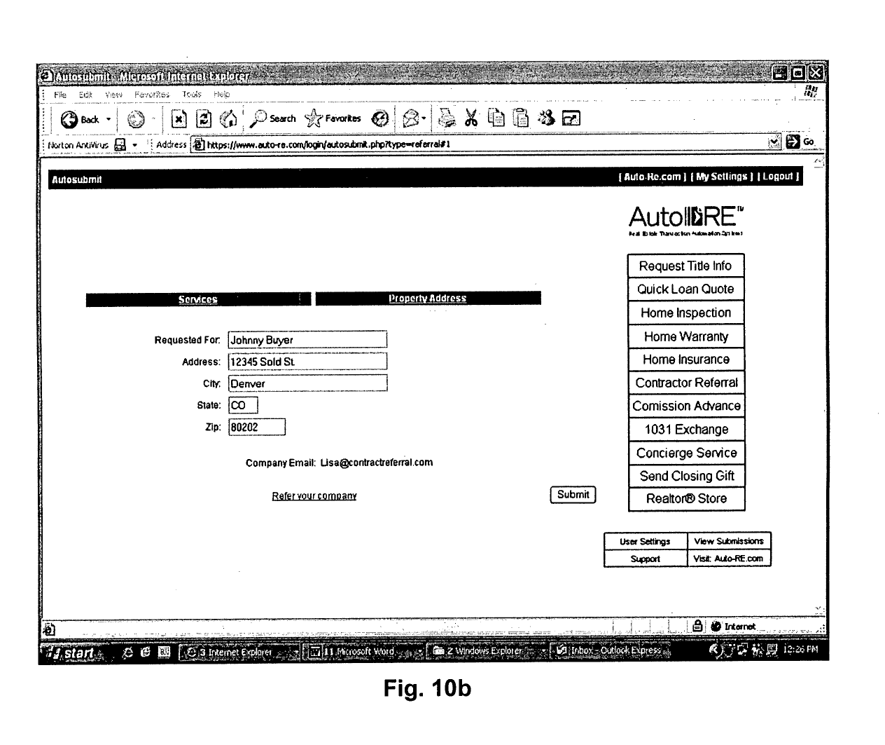

FIG. 10a shows a property maintenance supplementary screen, which allows the user to enter or select the company the request is being sent to, whom the services are being requested for, and the services being requested. The information comprising the request for property maintenance is presently generally provided to the home maintenance company over the phone. Utilizing the present invention obtains price quotes and eliminates the need to repeatedly relay the information over the phone to different home maintenance companies. The property maintenance auto-submission screen shown in FIG. 10b comprises fields for the property address, the buyer's name or seller's name, and contact information for the buyer or seller, depending on which party is requesting the maintenance.

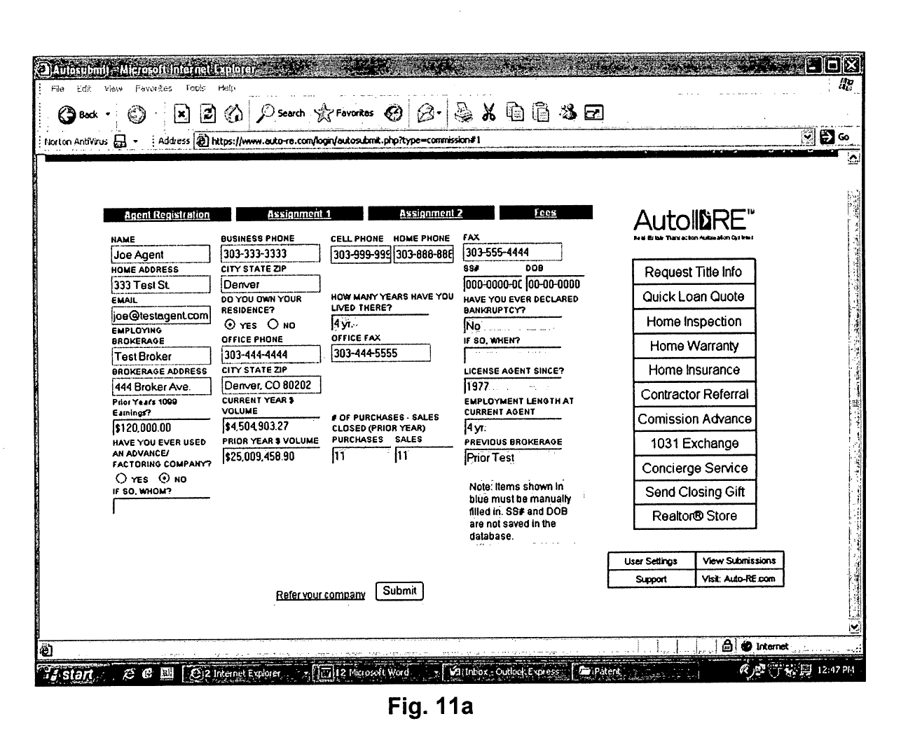

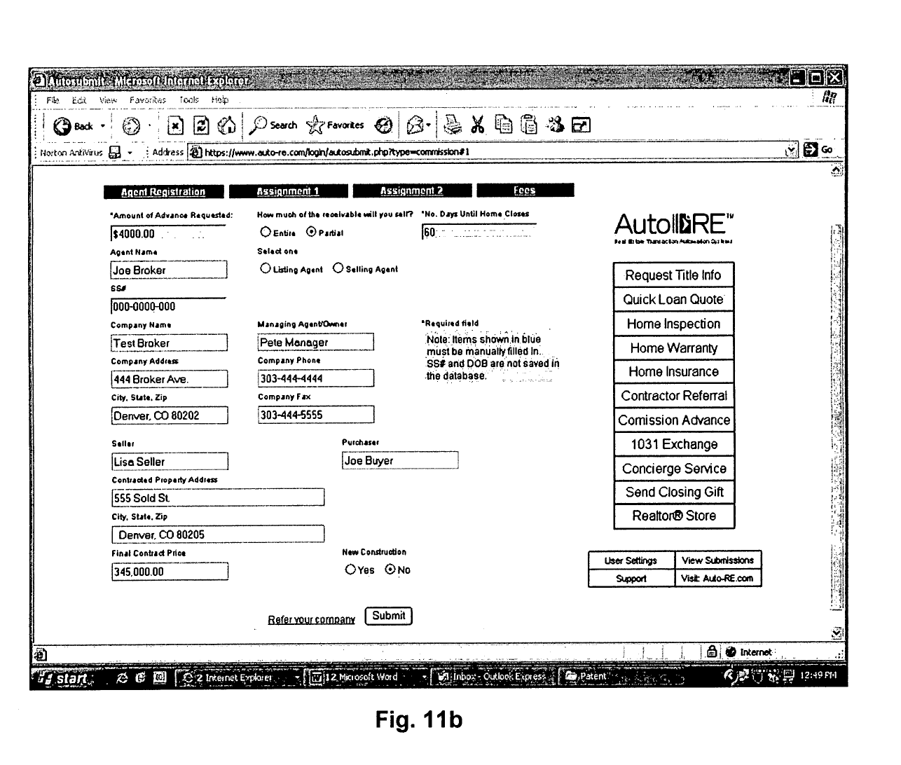

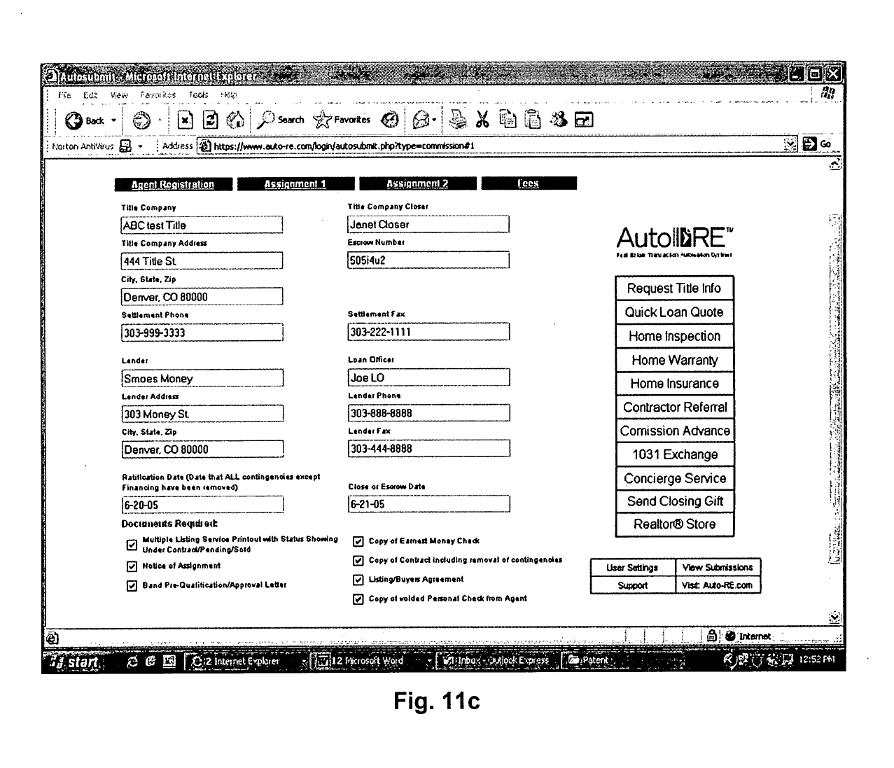

FIGS. 11a and 11c show commission advance supplementary screens, which allow the user to enter or select information such as the name and contact information of the agent requesting the commission advance, the title company, title closer, name and contact information of the lender, and the close or escrow date. FIG. 11b shows a commission advance auto-submission screen which contains auto-populated information such as the buyer's name and seller's name, property address, and final contract price. The commission advance auto-submission screen also allows the user to enter or select additional information such as the amount of advance requested, the name and contact information of the company the agent works for, whether the agent is the listing agent or selling agent, and the agent's social security number.

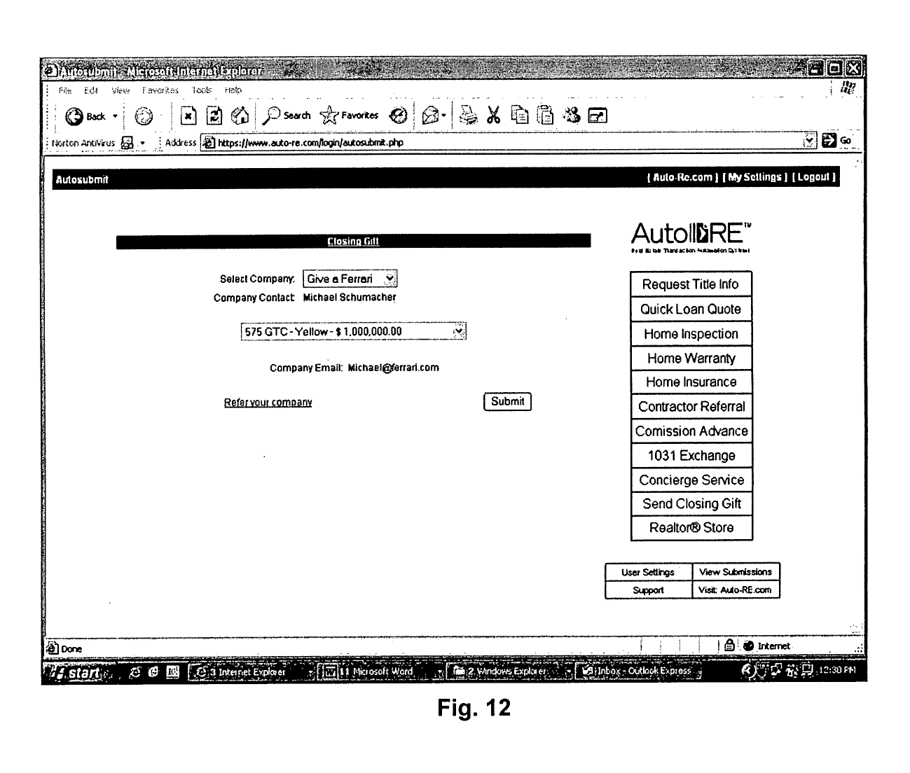

FIG. 12 shows purchase closing gifts auto-submission screen. The real estate professional can enter or select a gift from a predetermined list of participating retailers, which automatically purchases a closing gift. The real estate professional is able to print a credit card authorization form and agreement, and fax the form to selected participating retailers on the menu. This eliminates the need for the real estate professional to purchase a gift at store.

Specific information contained in the data subsets auto-populated into each auto-submission screen in one embodiment of the invention is summarized in Table 1. Table 1 further classifies the information as the type of information originating from a Buy/Sell Contract or Listing Contract, although it should be noted that much of this information could also be auto-populated from an electronic database or a software or internet application.

TABLE 1

| Auto-Submission | Buy/Sell Contract | Listing Contract |
|---|---|---|
| Screen | Auto-populated Information | Auto-populated Information |
| O & E Request | | Seller name, property address, |
| Title Information | | county, city, state, zip code, legal |
| | | description. |
| Title Commitment | | |
| Title Purchase Form | | |
| Request for Mortgage | Buyer name (Name of borrower), | Seller name (Name of borrower), |
| Loan Quote | property address, city, state, zip | current property address, city, state, |
| | code, purchase amount, down | zip code, phone/fax/email. |
| | payment amount, phone/fax/ | |
| | email. | |
| Request for Home | Buyer name, property address, city, | Seller name, property address, city, |
| Inspection | state, zip code, legal description, | state, zip code, legal description, |
| | phone/fax/email. | phone/fax/email. |
| 1031 Exchange | Buyer name, property address, city, | Seller name, property address, city, |
| | state, zip code legal description, | state, zip code, legal description, |
| | phone/fax/email, contract date, | phone/fax/email, contract date. |
| | closing date. | |
| Property Insurance | Buyer name, property address, city, | Seller name, property address, city, |
| | state, zip code legal description, | state, zip code, legal description, |
| | purchase amount, down payment | phone/fax/email. |
| | amount, phone/fax/email. | |
| Application for Home | Buyer name, property address, city, | Seller name, property address, city, |
| Warranty | state, zip code, buyer phone/fax | state, zip code, seller phone/fax/ |
| | number, seller name, seller | email, number. |
| | address, seller phone/fax/email, | |
| | number, contract date, closing date | |
| Request for Home | Buyer name, buyer current address, | Seller name, property address, city, |
| Maintenance | city, state, zip code, buyer phone/ | state, zip code, seller phone/fax/ |
| | fax number | email, number. |
| Commission Advance | Buyer name, property address, city, | |
| | state, zip code, buyer phone/fax | |
| | number, seller name, seller | |
| | address, seller phone/fax/email, | |
| | number, contract date, closing date | |
| Purchase Closing | Buyer name, buyer address, city, | Seller name, seller address, city, |
| Gifts | state, zip code, buyer phone/fax/ | state, zip code, seller phone/fax/ |
| | email, number. | email, number. |
| | Auto-populate and print and fax | Auto-populate and print and fax credit |
| | credit card authorization form. | card authorization form. Including: |
| | Including: real estate agent | real estate agent information, client |
| | information, client information, and | information, and closing gift provider |
| | closing gift provider information, | information. |

As illustrated in the figures, additional information may be added to the auto-populated information in the auto-submission screen or in a separate supplementary screen. In both instances, the additional information is combined with the auto-populated information and transmitted to the service provider. As an example, a title information auto-submission screen, similar to the screen shown in FIG. 4a, may contain only auto-populated information, while the additional information can be entered in a supplementary screen similar to in FIG. 4b. Alternatively, an auto-submission screen, such as the mortgage loan quote auto-submission screen shown in FIG. 5b, may contain both auto-populated information (the buyer's or seller's name and contact information) and additionally entered or selected information (FICO score and type or borrower).

Information that is optionally selected or entered into auto-submission screens or supplemental screens and combined with the auto-populated information in one embodiment of the invention is summarized in Table 2.

TABLE 2

| Auto-Submission | |
|---|---|
| Screen | Selected and Entered Information |
| Request for Title | Attach Listing Contract |
| Information | |
| Request for Loan Quote | Select Mortgage Company, Type of Borrower, including: first time |
| | buyer, investment, second home, refinance, experienced buyer |
| | and construction; Rent or Own, Type of Credit, including - choice |
| | of A, B, C, D, or entering a credit score, type of loan requested, |
| Request for Home | Select Inspection Company, Property Square Footage, Age of the |
| Inspection | Property, Type of Service Requested, including: radon, pool, spa, |
| | sewer, septic tank, termites, lead or water, Preferred Inspection |
| | Dates and Times. (we feature a revised comprehensive inspection |
| | data sheet with more information that listed here) |
| 1031 Exchange | Title Company, Title Closer |
| Property Insurance | Square footage, year built; type of construction: ranch, two story, |
| | tri level, condo, town home; type of structure: frame, brick, stucco; |
| | type of property: primary residence, rental property, commerical, |
| | type of roof, age of roof. |
| Application for Home | Select any information included in the home warranty, including: |
| Warranty | roof, pool, plumbing systems, hot tub, washer, dryer, water heater, |
| | dish washer, garage door opener, garbage disposal, duct work, |
| | heating system, refrigerator, electrical, well, built in microwave, |
| | stove, central vacuum, trash compactor, air conditioning or |
| | evaporative cooler, septic tank, inspection fee. |
| Request for Home | Select: Service Type, including - repair, service, project. Services |
| Maintenance | Requested, including - plumbing, painting, handyman, house |
| | cleaning, gutters, garage, electrical, hauling. Landscaping, lawn |
| | care, roof, siding, concrete, kitchen remodel, basement, windows, |
| | appliances, locks, security system, interior design, window |
| | cleaning, trash dumpsters, fence, carpet cleaning, air duct |
| | cleaning, deck, floors, carpet cleaning. Services Requested For, |
| | including - buyer, seller, sellers agent, buyer agent. Timing, |
| | including - need yesterday, within one week, within two weeks. |
| Purchase Closing Gifts | Select closing gift company, closing gift choice. credit card |
| | authorization form |

Some of the auto-submission screens or screens are independent in that each form or screen contains information that is universal throughout the real estate industry. Universal auto-submission screens can be sent to any service provider, either as an email or text message, or to auto-populate a database or application accessible or operated by the service provider. The auto-submission screen for title information is auto-populated with all of the required information and can be submitted to any title company of choice. The mortgage loan quote auto-submission screen can also be sent to any mortgage company or loan officer and contains all of the required information except for social security number and date of birth, which require a secure connection in order to send. The property inspection, 1031 exchange, and property insurance auto-submission screens also contain all of the required information and can be sent to any company providing the service.

Some of the auto-submission screens or screens will be specific for the service provider or require specialized companies associated with the service. For example, home warranty or property warranty companies have specific pricing plans and programs. The property warranty auto-submission screen will contain information customized for the selected home warranty company. Similarly, several national commission advance companies exist and provide advances on commissions with varying rates per transaction. Requests for commission advances will therefore contain information specific for each commission advance company. Additionally, closing gifts can be automatically purchased from participating malls, restaurants, or smaller specialized companies. Concierge service companies do business in many communities and can be hired to complete specific tasks.

Additionally, many times when a real estate professional lists a property for sale, the property requires repairs or maintenance. The real estate professional often will have to schedule multiple contractors for these projects, and meets the contractor at the property. This process can be inconvenient and take several hours of time. Free contractor referral services do business in many communities. A contract referral auto-submission screen will detail the services needed and submit the request to the referral service. The service will send one of their contractors to the property and then send, preferably by email, a quote. This process saves the real estate professional hours of time. The contract referral auto-submission screen will contain information unique for each job and for each referral service.

While the invention has been described with certain preferred embodiments, it is understood that the preceding description is not intended to limit the scope of the invention. It will be appreciated by one skilled in the art that various equivalents and modifications can be made to the invention shown in the specific embodiments without departing from the spirit and scope of the invention.

1. A method of automating a real estate transaction comprising the steps:
a) identifying a data set in at least one electronic real estate form, database, software application, or internet application containing information relating to said transaction, where said at least one real estate form, database, software application, or internet application is stored on an electronic storage device;
b) auto-populating a subset of said data set into at least one auto-submission screen; and
c) transmitting said at least one auto-submission screen containing said data subset to one or more service providers, wherein said data subset contains information necessary to request a service from said service provider.

2. The method of claim 1 wherein the data subset is auto-populated from an electronic database stored on a computer processor.

3. The method of claim 2 wherein said computer processor is part of a server accessible to multiple computers connected to a network.

4. The method of claim 1 wherein the data subset is auto-populated from a software application or internet application used by a real estate professional.

5. The method of claim 1 wherein the data subset is auto-populated from an electronic real estate form stored on a computer processor.

6. The method of claim 1 wherein said one or more auto-submission screens containing said data subset are transmitted to a second computer processor through a computer network, where said second computer processor is accessible to, or operated by, said one or more service providers.

7. The method of claim 6 wherein said data subset transmitted in said one or more auto-submission screens is auto-populated into a database, software application, or internet application stored on said second computer processor.

8. The method of claim 1 wherein said one or more auto-submission screens are transmitted to said one or more service providers using email or instant text messaging.

9. The method of claim 1 wherein said service provider performs a service selected from the group consisting of title insurance, mortgage loan, property inspection, property warranty, property maintenance, property insurance, contractor referral, commission advance, 1031 exchange information, quotes for said services and combinations thereof.

10. The method of claim 1 comprising more than one auto-submission screens wherein each auto-submission screen is transmitted to a different service provider.

11. The method of claim 1 further comprising providing to a real estate professional a computer program able to perform said method.

12. A method of automating a real estate transaction comprising the steps:
a) generating an auto-submission screen on a computer screen, wherein said auto-submission screen corresponds to a real estate related service;
b) linking said auto-submission screen with an electronic real estate form, database, software application, or internet application containing information relating to said transaction;
c) identifying a data set relating to said transaction in said electronic real estate form, database, software application, or internet application;
d) extracting a subset of said data set from said electronic real estate form, database, software application, or internet application;
e) auto-populating said data subset into said auto-submission screen; and
f) electronically transmitting a request to a service provider, said request comprising said data subset contained in said auto-submission screen.

13. The method of claim 12 comprising more than one auto-submission screens wherein said data subset in each auto-submission screen is transmitted to a different service provider.

14. The method of claim 12 further comprising providing a menu display on a computer screen, said menu display containing an auto-submission selection button corresponding to said auto-submission screen, wherein selecting said auto-submission selection button generates the corresponding auto-submission screen.

15. The method of claim 12 wherein said auto-submission screen containing said data subset is transmitted to a second computer processor accessible to, or operated by, said service provider.

16. The method of claim 15 wherein said auto-submission screen containing said data subset is electronically transmitted through a computer network.

17. The method of claim 16 further comprising auto-populating said data subset contained in said transmitted auto-submission screen into a database, software application, or internet application stored on said second computer processor.

18. The method of claim 12 wherein said transmitted request is for a service selected from the group consisting of: title insurance, mortgage loan, property inspection, property warranty, property maintenance, contractor referral, commission advance, 1031 exchange information, quotes therefor and combinations thereof.

19. The method of claim 12 where said auto-submission screen is a title information auto-submission screen, wherein the data subset auto-populated into said title information auto-submission screen comprises: seller's name, property address, and legal description.

20. The method of claim 12 wherein said auto-submission screen is a mortgage loan quote auto-submission screen, wherein the data subset auto-populated into said mortgage loan quote auto-submission screen comprises: buyer's name or seller's name, property address, purchase amount, down payment amount, and contact information for the buyer or seller.

21. The method of claim 12 where said auto-submission screen is a property inspection auto-submission screen, wherein the data subset auto-populated into said property inspection auto-submission screen comprises: buyer's name or seller's name, property address, legal description, and contact information for the buyer or seller.

22. The method of claim 12 where said auto-submission screen is a 1031 exchange auto-submission screen, wherein the data subset auto-populated into said 1031 exchange auto-submission screen comprises: buyer's name or seller's name, property address, legal description, contract date, closing date information, and contact information for the buyer or seller.

23. The method of claim 12 where said auto-submission screen is a property insurance auto-submission screen, wherein the data subset auto-populated into said property inspection auto-submission screen comprises: buyer's name or seller's name, property address, legal description, purchase amount, and contact information for the buyer or seller.

24. The method of claim 12 where said auto-submission screen is a property warranty auto-submission screen, wherein the data subset auto-populated into said property warranty auto-submission screen comprises: buyer's name or seller's name, property address, contract date, closing date, and contact information for the buyer or seller.

25. The method of claim 12 where said auto-submission screen is a property maintenance auto-submission screen, wherein the data subset auto-populated into said property maintenance auto-submission screen comprises: buyer's name or seller's name, property address, legal description, and contact information for the buyer or seller.

26. The method of claim 12 where said auto-submission screen is a commission advance auto-submission screen, wherein the data subset auto-populated into said commission advance auto-submission screen comprises: buyer's name, seller's name, property address, legal description, contract date, closing date and contact information for the buyer and seller.

27. A computer program product comprising:
a) a computer program capable of:
i) identifying a data set in at least one real estate form, database, software application, or internet application containing information relating to said transaction, where said at least one real estate form, database, software application, or internet application is stored on an electronic storage device;
ii) auto-populating a subset of said data set into at least one auto-submission form; and
iii) transmitting said at least one auto-submission screen containing said data subset to at least one service provider, wherein said data subset contains information necessary to request a service from said service provider; and
b) an electronic device storing said program.

28. The computer program product of claim 27 where said electronic storage device storing said program is a disk, CD, DVD, computer hard drive, or computer processor.

29. The computer program product of claim 27 where said real estate form is a real estate form generated by said computer program.
